(19) United States
(12) Patent Application Publication
(10) Pub. No.: US 2021/0233422 A1
(43) Pub. Date: Jul. 29, 2021

(54) PHYSICALLY INTUITIVE MULTIPLE OBJECT TRACKING, PLANNING AND DIVIDED ATTENTION TASK FOR ENHANCING COGNITION

(71) Applicant: LUMOS LABS, INC., San Francisco, CA (US)

(72) Inventors: David Ethan KENNERLY, San Francisco, CA (US); Benjamin Lee AHRONI, San Francisco, CA (US); Aaron KALUSZKA, Hayward, CA (US)

(73) Assignee: LUMOS LABS, INC., San Francisco, CA (US)

(21) Appl. No.: 17/226,280

(22) Filed: Apr. 9, 2021

Related U.S. Application Data
(63) Continuation of application No. 29/702,667, filed on Aug. 21, 2019, now Pat. No. D916833.
Application No. 29/702,667 is a continuation of application No. 29/588,353, filed on Dec. 20, 2016, now Pat. No. D857707.
Application No. 29/588,353 is a continuation of application No. 14/338,165, filed on Jul. 22, 2014, now abandoned.
(60) Provisional application No. 61/857,753, filed on Jul. 24, 2013.

(51) Int. Cl. G09B 5/02

(52) U.S. Cl. CPC G09B 5/02

(57) ABSTRACT

A method and apparatus for enhancing a cognitive ability of a user may comprise: conducting, via a user interface display of a user computing device, a training session which may comprise: presenting a transportation routing network having a source of travelers and a respective unique destination for each traveler and a path from the source to the respective unique destination, each path comprising at least one direction modification element operable by the user to correctly direct the traveler from the source to the respective unique destination; displaying to the user a traveler moving along a path from the source to the at least one direction modification element; allowing the user to control the position of the at least one direction modification element so as to direct the traveler from the source to the respective unique destination.

### CROSS-REFERENCE

This application claims is a continuation of U.S. Design application 29/702,667 which is a continuation of U.S. Design application 29/588,353, which is a continuation of U.S. Utility application Ser. No. 14/338,165 which claims the benefit of Provisional Application No. 61/857,753, filed Jul. 24, 2013, which applications are incorporated herein in their entirety by reference.

### BACKGROUND

Divided attention refers to the ability to simultaneously attend to and respond to multiple tasks or multiple task demands. This ability is important and common in everyday life, as individuals are often performing multiple tasks at once, but attentional resources have limited capacity. See, PONDS, et al. Age differences in divided attention in a simulated driving task. Journal of Gerontology, 43(6), P151-P156 (1988). Enhancing this capacity is highly desirable.

Studies have shown that divided attentional abilities can be increased with practice. Consequently, there have been a number of attempts to develop programs to enhance attentional resource capacity. See, SPELKE, et al. Skills of divided attention. Cognition, 4(3), 215-230 (1976); SOHLBERG, et al. Effectiveness of an attention-training program. Journal of Clinical and Experimental Neuropsychology, 9(2), 117-130 (1987); RUEDA, et al. Training, maturation, and genetic influences on the development of executive attention. Proceedings of the national Academy of Sciences of the United States of America, 102(41), 14931-14936 (2005). These promising approaches demonstrate the appeal of attention training; however, they are not without their limitations. In particular, they do not challenge users in a continuous and distributed process, which limits their ecological validity and effectiveness. Sustained attention tasks are often boring due to the requirement of vigilance during a repetitive task with infrequent interactivity. A task performed in real-time without set intervals engages the user continuously, avoiding the problems associated with traditional tasks. Such tasks can be adapted in real-time to maximize challenge to users.

Organic tasks requiring the distribution of attention activate cingulate and prefrontal cortices in a robust and ecologically relevant manner. They also have the advantage of being relatively easy tasks to understand, unlike the unnatural operations found in many attention tasks. Tasks that include a planning component and active decision-making rather than a pure response component also engage other cognitive systems, such as those involved in working memory.

### SUMMARY OF THE INVENTION

Cognitive training exercises are described. In the exemplary exercises, the exercises are adaptable to train divided and distributed attentional abilities in an intuitive, engaging, and adaptively challenging way to enhance cognition. The exercises engage users in a task where they direct a continuous stream of items, e.g., transportation vehicles, such as trains, to a destination by, for example, toggling switches on tracks, e.g., to create a path, such as a route or course, in real time from a source of the transportation vehicles to a destination. Through attentional and executive control mechanisms, the user continuously track the trains, plan their routes, and toggle the switches when necessary in order to complete the physically realistic task, and, e.g., adjusts the paths in real time to allow for a first vehicle passing over a switch to go in the necessary desired direction through the switch, and a subsequent transportation vehicle to go in another selected necessary desired direction through the switch.

A method and apparatus for enhancing a cognitive ability of a user, are disclosed which may comprise: conducting, via a user interface display of a user computing device, a training session which may comprise: presenting, via the user interface display of the user computing device, a transportation routing network having a source of travelers and a respective unique destination for each traveler and a path from the source to the respective unique destination, each path comprising at least one direction modification element operable by the user, via the user interface display of the user computing device, to correctly direct the traveler from the source to the respective unique destination; displaying to the user, via the user interface display of the user computing device, a traveler moving along a path from the source to the at least one direction modification element; allowing the user, via the user interface display of the user computing device, to control the position of the at least one direction modification element so as to direct the traveler from the source to the respective unique destination.

The method and apparatus may further comprise wherein the transportation routing network comprises a multipath transportation routing network comprising a plurality of unique destinations each connectable to the source through a unique path in a network of paths. The destinations can be two or more, three or more, and the like. The traveler may comprise a plurality of travelers sequentially delivered from the source and uniquely identified with one of the plurality of unique destinations. The method and apparatus may further comprise recording, via the user computing device, whether the user successfully directs a respective traveler from the source to the respective unique destination through the control by the user, via the user interface display of the user computing device, of the at least one direction modification element. The method and apparatus may further comprise each of the plurality of travelers comprising a representation of a train engine and the multipath transportation routing network comprising tracks for the train engine to follow and each direction modification element comprising a switch for the train engine to pass over. The method and apparatus may further comprise wherein the respective traveler and the respective unique destination for the traveler are identified by same color.

The method and apparatus may further comprise wherein the complexity of the training session is determined by the user computing device from least one of: the number of unique destinations, the number of direction modification elements between the source and the respective unique destination and the speed of delivery of travelers from the source. The method and apparatus may further comprise enhancing the complexity of the training session by requiring the user, via the user interface display of the user computing device, to sequentially control the position of at least one direction modification element at least twice to direct a first traveler to a first unique destination and a second traveler to a second unique destination after the first traveler passes through the direction modification element and before the second traveler reaches the direction modification element, wherein the second traveler is displayed to be moving toward the respective at least one direction modification element before the first traveler has passed through the respective at least one direction modification element. The method and apparatus may further comprise increasing or decreasing, via the user computing device, the complexity of the training session according to user performance during the training session.

Also disclosed is a machine readable medium storing instructions that, when executed by a computing device cause the computing device to perform a method which may comprise conducting a training session comprising: presenting a transportation routing network having a source of travelers and a respective unique destination for each traveler and a path from the source to the respective unique destination, each path comprising at least one direction modification element operable by the user, via the user computing device user interface display, to correctly direct the traveler from the source to the respective unique destination; displaying to the user a traveler moving along a path from the source to the at least one direction modification element; and allowing the user to control the position of the at least one direction modification element so as to direct the traveler from the source to the respective unique destination. The machine readable medium may comprise, wherein the transportation routing network comprises a multipath transportation routing network comprising a plurality of unique destinations each connectable to the source through a unique path in a network of paths.

An aspect of the disclosure is directed to a method of enhancing a cognitive ability of a user. Suitable methods comprise: conducting, via a user interface display of a user computing device, a training session comprising: presenting, via the user interface display of the user computing device, a routing network having only one or more than one travelers, a source for each of the one or more travelers, a respective destination for each of the one or more travelers, and a path from the source for the one or more travelers to the respective destination of the one or more travelers, each network comprising at least one direction modification element to direct a traveler of the one or more travelers from the source to the respective unique destination; displaying to the user, via the user interface display of the user computing device, the traveler moving along the path from the source to the at least one direction modification element; allowing the user, via the user interface display of the user computing device, to control a position of the at least one direction modification element so as to direct the traveler to the respective destination for the traveler. A suitable routing network can also comprise a multipath routing network comprising a plurality of unique destinations each connectable to the source through a unique path in a network of paths. The traveler can comprise a plurality of travelers sequentially or in parallel delivered from the source and uniquely identified with one of the plurality of unique destinations. Additionally, recording, via the user computing device, whether the user successfully directs a respective traveler from the source to the respective unique destination through the control by the user, via the user interface display of the user computing device, of the at least one direction modification element. The system can determine whether the user directs the traveler to the correct destination as well as how the user directs the traveler to the destination that is reached. The plurality of travelers can, for example, be a representation of a train and the multipath routing network comprises tracks for the train to follow and each direction modification element comprises a switch for the train to pass over. Alternatively, the plurality of travelers can comprises a representation of a vehicle and the routing network comprises paths for the vehicle to follow. Other travelers and network representations can be employed including, but not limited to hiker and trail, walker and sidewalk, runner and running path, etc. Additionally, the respective unique destination for a traveler can be identified by one or more of each of shape, color, and size. Additionally, the complexity of the training session can be determined by the user computing device from least one of: the number of unique destinations, the number of direction modification elements between the source and the respective unique destination and the speed of delivery of travelers from the source. Additional aspects of the disclosure include enhancing the complexity of the training session by requiring the user, via the user interface display of the user computing device, to sequentially control the position of at least one direction modification element at least twice to direct a first traveler to a first unique destination and a second traveler to a second unique destination after the first traveler passes through the direction modification element and before the second traveler reaches the direction modification element, wherein the second traveler is displayed to be moving toward the respective at least one direction modification element before the first traveler has passed through the respective at least one direction modification element. In at least some instances, increasing or decreasing, via the user computing device, the complexity of the training session according to user performance during the training session can also occur.

Yet another aspect of the disclosure is directed to an apparatus for enhancing a cognitive ability of a user. Suitable apparatuses comprise: a user computing device configured to: conduct a training session, utilizing a user interface display of the user computing device, comprising: presenting a routing network having one or more travelers, a source for each of the one or more travelers, a respective destination for each of the one or more travelers, and a path from the source for the one or more travelers to the respective destination, each network comprising at least one direction modification element operable by the user, via the user interface display of the user computing device, to direct a traveler of the one or more travelers from the source to the respective unique destination; displaying to the user the traveler moving through the network from the source to the at least one direction modification element; allowing the user, via the user interface display of the user computing device, to control a position of the at least one direction modification element so as to direct the traveler from the source to the respective unique destination. A suitable routing network can also comprise a multipath routing network comprising a plurality of unique destinations each connectable to the source through a unique path in a network of paths. The traveler can comprise a plurality of travelers sequentially or in parallel delivered from the source and uniquely identified with one of the plurality of unique destinations. Additionally, recording, via the user computing device, whether the user successfully directs a respective traveler from the source to the respective unique destination through the control by the user, via the user interface display of the user computing device, of the at least one direction modification element. The system can determine whether the user directs the traveler to the correct destination as well as how the user directs the traveler to the destination that is reached. The plurality of travelers can, for example, be a representation of a train and the multipath routing network comprises tracks for the train to follow and each direction modification element comprises a switch for the train to pass over. Alternatively, the plurality of travelers can comprises a representation of a vehicle and the routing network comprises paths for the vehicle to follow. Other travelers and network representations can be employed including, but not limited to hiker and trail, walker and sidewalk, runner and running path, etc. Additionally, the respective unique destination for a traveler can be identified by one or more of each of shape, color, and size. Additionally, the complexity of the training session can be determined by the user computing device from least one of: the number of unique destinations, the number of direction modification elements between the source and the respective unique destination and the speed of delivery of travelers from the source. Additional aspects of the disclosure include enhancing the complexity of the training session by requiring the user, via the user interface display of the user computing device, to sequentially control the position of at least one direction modification element at least twice to direct a first traveler to a first unique destination and a second traveler to a second unique destination after the first traveler passes through the direction modification element and before the second traveler reaches the direction modification element, wherein the second traveler is displayed to be moving toward the respective at least one direction modification element before the first traveler has passed through the respective at least one direction modification element. In at least some instances, increasing or decreasing, via the user computing device, the complexity of the training session according to user performance during the training session can also occur.

Still another aspect of the disclosure is directed to a machine readable medium storing instructions that, when executed by a computing device cause the computing device to perform a method comprising: conducting a training session comprising: presenting a routing network having one or more travelers, a source for each of the one or more travelers, a respective destination for each of the one or more travelers, and a path from the source for the one or more travelers to the respective destination, each path comprising at least one direction modification element operable by the user, via the user interface display of the user computing device, to direct a traveler of the one or more travelers from the source to the respective unique destination; displaying to the user the traveler moving along the path from the source to the at least one direction modification element; allowing the user to control a position of the at least one direction modification element so as to direct the traveler from the source to the respective unique destination. A suitable routing network can also comprise a multipath routing network comprising a plurality of unique destinations each connectable to the source through a unique path in a network of paths. The traveler can comprise a plurality of travelers sequentially or in parallel delivered from the source and uniquely identified with one of the plurality of unique destinations. Additionally, recording, via the user computing device, whether the user successfully directs a respective traveler from the source to the respective unique destination through the control by the user, via the user interface display of the user computing device, of the at least one direction modification element. The system can determine whether the user directs the traveler to the correct destination as well as how the user directs the traveler to the destination that is reached. The plurality of travelers can, for example, be a representation of a train and the multipath routing network comprises tracks for the train to follow and each direction modification element comprises a switch for the train to pass over. Alternatively, the plurality of travelers can comprises a representation of a vehicle and the routing network comprises paths for the vehicle to follow. Other travelers and network representations can be employed including, but not limited to hiker and trail, walker and sidewalk, runner and running path, etc. Additionally, the respective unique destination for a traveler can be identified by one or more of each of shape, color, and size. Additionally, the complexity of the training session can be determined by the user computing device from least one of: the number of unique destinations, the number of direction modification elements between the source and the respective unique destination and the speed of delivery of travelers from the source. Additional aspects of the disclosure include enhancing the complexity of the training session by requiring the user, via the user interface display of the user computing device, to sequentially control the position of at least one direction modification element at least twice to direct a first traveler to a first unique destination and a second traveler to a second unique destination after the first traveler passes through the direction modification element and before the second traveler reaches the direction modification element, wherein the second traveler is displayed to be moving toward the respective at least one direction modification element before the first traveler has passed through the respective at least one direction modification element. In at least some instances, increasing or decreasing, via the user computing device, the complexity of the training session according to user performance during the training session can also occur. Additionally, methods of assessing a cognitive ability of a user are disclosed. Suitable methods comprise: conducting, via a user interface display of a user computing device, a training session comprising: presenting, via the user interface display of the user computing device, a routing network having one or more travelers, a source for each of the one or more travelers, a respective destination for each of the one or more travelers, and a path from the source for the one or more travelers to the respective destination, each network including at least one direction modification element to direct a traveler of the one or more travelers from the source to the respective unique destination; displaying to the user, via the user interface display of the user computing device, the traveler moving along the path from the source to the at least one direction modification element; allowing the user, via the user interface display of the user computing device, to control a position of the at least one direction modification element so as to direct the traveler to its destination; determining the performance of the user by determining one or more of whether the traveler was directed to the correct respective destination and which path the traveler used to get to the destination; using that performance to evaluate the cognitive ability of the user. The cognitive ability of such methods can include, for example, one or more of attention and divided attention. Additionally, the performance of the user is determined by determining the complexity of the training session from at least one of: the number of unique destinations, the number of direction modification elements between the source and the respective unique destination and the speed of delivery of travelers from the source.

### INCORPORATION BY REFERENCE

All publications, patents, and patent applications mentioned in this specification are herein incorporated by reference to the same extent as if each individual publication, patent, or patent application was specifically and individually indicated to be incorporated by reference for all purposes, and in total, including specification, claims and drawings as applicable, as if incorporated verbatim in the present application.

### BRIEF DESCRIPTION OF THE DRAWINGS

Aspects of the disclosure subject matter are set forth with particularity in the appended claims. A better understanding of the features and advantages of the disclosure subject matter may be obtained by reference to the following detailed description that sets forth illustrative embodiments, in which the principles of the structure and operation of the disclosed subject matter are utilized and explained by way of example only, and the accompanying drawings of which:

FIG. 1A illustrates a traveler following a direction of a switch where the switch is the only variable element with which the traveler may interact, according to aspects of the disclosed subject matter;

FIG. 1B illustrates a traveler directed to its corresponding destination wherein an indicator designates a correct response, according to aspects of the disclosed subject matter;

FIG. 1C illustrates a traveler directed a destination other than to its corresponding destination wherein an indicator designates an incorrect response, according to aspects of the disclosed subject matter;

FIG. 2 illustrates a tutorial describing a method of interaction through a prompt, according to aspects of the disclosed subject matter;

FIG. 3 illustrates a tutorial describing a method of interaction through a prompt, according to aspects of the disclosed subject matter;

FIG. 4 illustrates a tutorial describing a method of interaction through a prompt, according to aspects of the disclosed subject matter;

FIG. 5 illustrates a tutorial describing a method of interaction through a prompt, according to aspects of the disclosed subject matter;

FIG. 6 illustrates exemplary interactive feedback provided by a tutorial, according to aspects of the disclosed subject matter;

FIG. 7 illustrates an ending for a tutorial which describes a strategy for the game, according to aspects of the disclosed subject matter;

FIG. 8 illustrates a screen shot wherein lower levels of the game have a smaller grid, fewer destinations and lower frequency, according to aspects of the disclosed subject matter;

FIG. 9 illustrates a screen shot wherein higher levels of the game have a larger grid and more destinations, higher frequency and more variance in the number of switches to a destination, according to aspects of the disclosed subject matter;

FIG. 10 is a screen shot illustrating each traveler following the direction of the switches in their current configuration, according to aspects of the disclosed subject matter;

FIG. 11 illustrates a screen shot showing an exemplar final screen containing a user's score, number of correct, and a message of progress towards a next destination, according to aspects of the disclosed subject matter;

FIG. 12 illustrates an exemplary game flow diagram, according to aspects of the disclosed subject matter;

FIG. 13 illustrates a flow diagram wherein once a destination of a traveler/train is known, the system and method is configurable to adapt difficulty and provide feedback to the user, according to aspects of the disclosed subject matter;

FIG. 14 illustrates a flow diagram wherein players are directed to play a tutorial and wherein game difficulty can be set, according to aspects of the disclosed subject matter; and

FIG. 15 illustrates a tutorial flow diagram, according to aspects of the disclosed subject matter.

### DETAILED DESCRIPTION OF THE INVENTION

A goal of the exercises presented to a user through screen displays generated on a user computing device screen display by the user computing device according to aspects of embodiments of the disclosed subject matter is to direct the user to control multiple moving objects, e.g., transportation vehicles, such as trains, which may be distinguished by the use of various distinguishing colors or designs on paths to corresponding destinations by changing or not changing the direction of intervening junction switches. The exercise can, e.g., require that the user visually track the multiple objects and find a path for each object to a corresponding destination in a continuous and real real-time manner and, e.g., wait to change the position of an intervening switch for a trailing transportation vehicle until a leading transportation vehicle has passed through the switch and in time for the trailing transportation vehicle pass through the switch in the changed position.

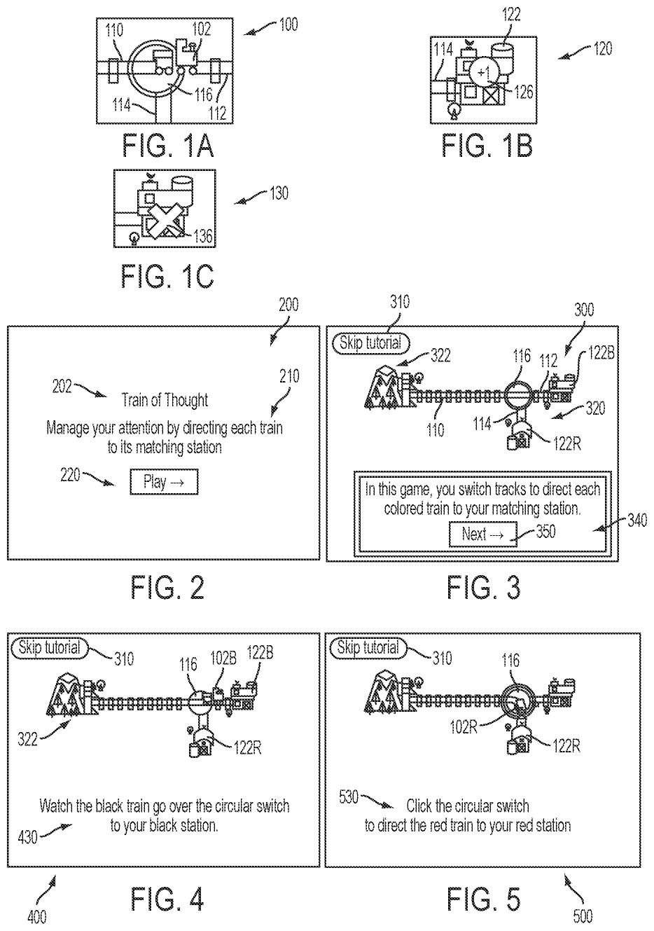

The core gameplay mechanic according to aspects of the disclosed subject matter may be for the user to attend to the multiple objects and the selection of the direction at each intervening junction switch. In one example disclosed here, each junction may be represented by a railroad switch 116, as illustrated by way of example in a portion of the screen display 100 of FIG. 1A. In one implementation, the direction of the switch 116 may be restricted, e.g., to a binary choice, such that, e.g., left clicking on the switch 116, or touching on the switch 116 on a touch screen display, can toggle the switch to the alternative position from that of the current selection of the switch 116. That is, as illustrated in FIG. 1A, the switch 116 is connecting an incoming track 110 to a first outgoing track 112, and toggling the switch 116 will connect the incoming track 110 to a second outgoing track 114.

However, as will be appreciated by those skilled in the art, in other implementations more than two choices can be provided from which a user may be able to select. That is, a given switch may be connected to an incoming track(s) 110 and/or there may be three outgoing tracks (e.g., first outgoing track 112, and second outgoing track 114), with the third outgoing track not shown. In such cases, toggling through the tracks may be selective first to the incoming track(s) and then to the outgoing tracks. Additionally, the position of the switch 116 direction could be selected, e.g., toggled by pointing and clicking a desired location from among the incoming tracks, if there are more than one, and to the first outgoing track 112, second outgoing track 114, or more, (not shown), with a computer mouse or other pointing device or by touching the location desired on a touch-sensitive device. Each switch 116 can thus be configurable to connect an incoming path to multiple outgoing paths, which is represented in this illustration by a railroad, with tracks and switches and trains moving along the tracks and over the switches. It will be understood by those skilled in the art that other physical representations of multipath transportation and routing systems, such as luggage sorting systems, cars or trucks traveling on roads, planes, assembly lines, etc., could be used without departing from the scope of the disclosed subject matter.

Each moving object, conceptually referred to hereafter as a traveler, e.g., the train 102 may have an ultimate destination, e.g., designated by being of the same color as the moving object. The destination 122 may be illustrated as a farm house at the end of incoming track 124 as shown in the portion of the screen 120 illustrated in FIG. 1B. When a moving object is directed along the proper path to reach the destination 122, by toggling the necessary switches 116 to the proper positions along the route, then the user may be notified with a correct solution indicator 126, e.g., indicating that the user has scored a +1. If the moving object, such as the train 102 reaches the wrong destination, as shown in the portion of the screen 130 illustrated in FIG. 1C, an incorrect response indicator, such as an “X,” 136 may be displayed, e.g., at the location of the screen display of the incorrect destination.

FIG. 2 illustrates, by way of example, an opening screen display 200 for the multiple object tracking, planning and routing cognitive training apparatus and method according to aspects of the disclosed subject matter. The opening screen display 200 may have a title 202, such as “Train of Thought,” a game objective 210, such as “Manage your attention by directing each train to its matching station. The screen display 200 may also display a “Play” button 220.

FIG. 3 illustrates a tutorial screen display 300. The tutorial screen display 300 may include an illustrative moving object routing display 320, which may include an incoming track 110, first outgoing track 112 and second outgoing track 114, a switch 116, a black destination indicator 122B, connected to the first outgoing track 112, and a red destination indicator 122R, connected to the second outgoing track 114. The illustrative moving object routing display 320 may further include a moving object source indicator 322, e.g., tunnel, connected to the incoming track 110. The illustrative moving object routing display 320 may further include a tutorial text display box, which may contain a tutorial text 340, such as “In this game, you switch tracks to direct each colored train to your matching station.” The tutorial screen display 300 may further include a “Next” button 350 for moving the user on to the next screen display, e.g., FIG. 4, illustrating a tutorial screen display 400, which may contain a tutorial text 430, e.g., “Watch the black train go over the circular switch to your black station,” and display an illustration of the black train 102B crossing the switch 116 toward the black destination indicator 122B. Similarly, FIG. 5, illustrates a tutorial screen display 500, which may contain the tutorial text 530, e.g., “Click the circular switch to direct the red train to your red station,” and display an illustration of the red train 102R turning through the switch 116 toward the red destination indicator 122R.

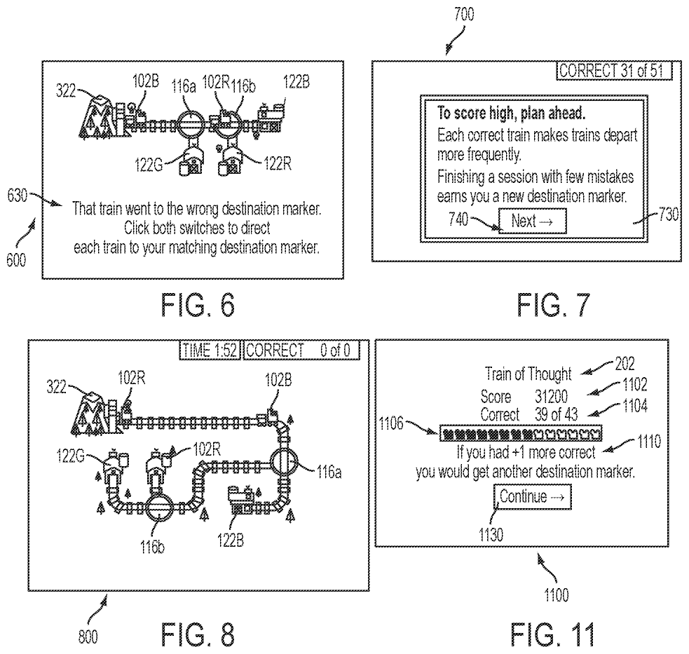

FIG. 6 illustrates a further tutorial screen display 600 which may contain a tutorial text 630, such as, “That train went to the wrong destination indicator. Click both switches to direct each train to your matching destination marker.” The tutorial screen display 600 may also illustrate the red train 102R approaching the black destination indicator 122B through the switch 116b, due to the switch 116b being toggled to the wrong position. As illustrated by way of example in FIG. 7 a further tutorial screen display 700 may include a tutorial text box 730, e.g., containing the tutorial “To score high, plan ahead. Each correct train makes trains depart more frequently. Finishing a session with few mistakes earns you a new destination marker.” The screen display 700 may also include a “Next” button 740.

Each moving object, e.g., a black train 102B or a red train 102R may be confined to a path in a network of paths, as indicated by the game play screen 800 in FIG. 8. In the illustrated embodiment of the disclosed subject matter, there is a single source 322 from which every traveler (i.e., a moving object, such as, a train) emerges. A plurality of potential termination locations can be provided, illustrated as black destination indicator 122B, red destination indicator 122R, and green destination indicator 122G. One or more switches can be provided, e.g., switch 116a and 116b. However, as will be appreciated by those skilled in the art, multiple sources from which the moving object emerges could be used without departing from the scope of the disclosure. According to aspects of the disclosed subject matter, the game playing display 800 may be arranged such that moving objects, such as travelers, e.g., comprising representations of a train, never collide or retrace paths. That is it may be that, there are no cycles in the network and there are no paths that merge together. However, it will be understood by those skilled in the art, that in other configurations, such collisions and operations may be allowed.

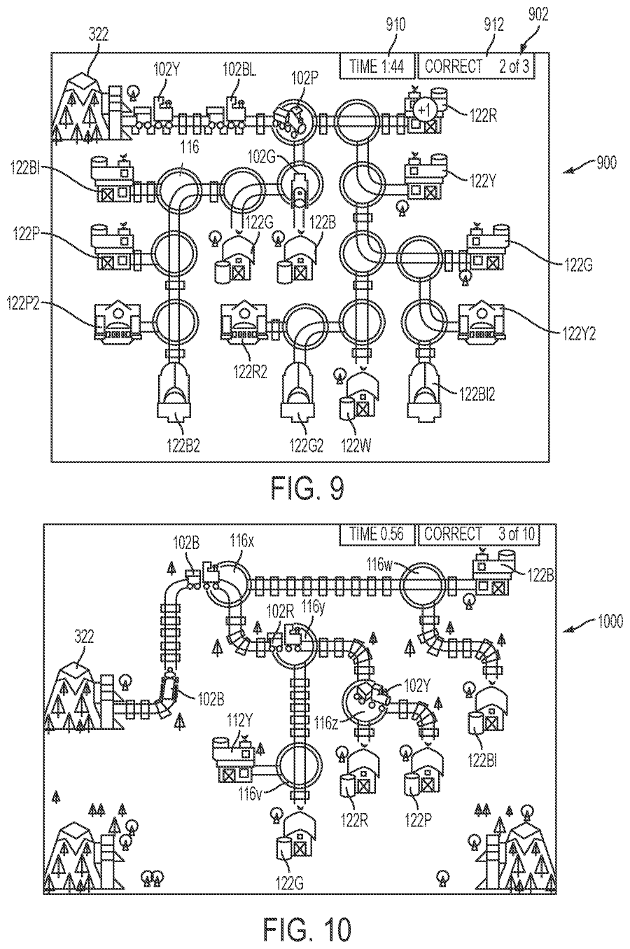

As illustrated in FIG. 8, the path on which the objects, e.g., a black train 102B and a red train 102R, travel may be constructed to fit onto a grid of varying dimension for simplicity, though other implementations could use other layouts. Each path may terminate at a distinct destination indicator, e.g., black destination indicator 122B, red destination indicator 122R and green destination indicator 122G. Other implementations could include duplicate or multiple destinations, e.g., as discussed in more detail below with respect to FIG. 9. Each traveler visually corresponds to at least one destination, for instance, by a unique combination of color and/or shape. If the user successfully directs a traveler, such as a black train 102B or a red train 102R, as illustrated in FIG. 8 to its corresponding destination, an indication of success appears, such as is disclosed in regard to FIG. 1B, and the user is rewarded for a correct trial. If the train is directed to any destination other than its corresponding color and/or shape, the user computing device is configured to generate an associated incorrect indicator, such as appears in FIG. 1C). The correct and incorrect indicators can be visual, auditory, and/or vibratory, or detectable by any other human sense.

According to aspects of the disclosed subject matter discussed above, and as discussed above, the user can be introduced to the cognitive training exercise(s) via a short interactive tutorial describing the gameplay elements and their use. The user can then start the training, e.g., at a relatively simple starting level, e.g., as illustrated in FIG. 6 or FIG. 8. A task and input method having been described and then a moving object, such as a traveler/train can be introduced to the network, e.g., as illustrated in FIG. 6 or FIG. 8. The moving object, such as the traveler/train, can then travel through the network, e.g., according to the currently selected position of any switch encountered and the user can then leave a selected switch(s) in place or toggle a chosen switch(es) to align the track path in front of the respective train to its respective destination location indicator. The train then arrives at a destination. If the destination is incorrect, then an indicator is displayed that the destination is incorrect, and, according to some embodiments of the disclosed subject matter, the user may be allowed to travel through the network again. If the destination is correct, then a correct destination indicator is displayed, e.g., at the destination location indicator and the user computing device can then determine how many points have been scored because the user directed the traveler/train correctly.

Having been prompted by the above described tutorials the user can complete a series of simple game configurations without the guided messages and prompts. Important gameplay features such as how the travelers/trains follow the path and how toggling the switch(es) determines the course of the traveler/train are illustrated in the animations of, e.g., paths like those illustrated in FIG. 6 or FIG. 8. Interactive feedback can be utilized by the user computing device to inform the user of success in understanding the task, and executing the task, and in some embodiments, the user may be given the chance to retry after making an error, which may include, e.g., rerouting only the train(s) that was improperly routed in the trial just completed. After a number of successful trials, e.g., at each new session, e.g., at each new level of difficulty, the player may then be invited to start the game. The tutorial(s) may also be recalled in the future, e.g., if a user needs to be reminded how to play and/or may be dismissed if not needed, e.g., by utilizing a displayed “Skip tutorial” button 310, such as is illustrated in FIGS. 3-5.

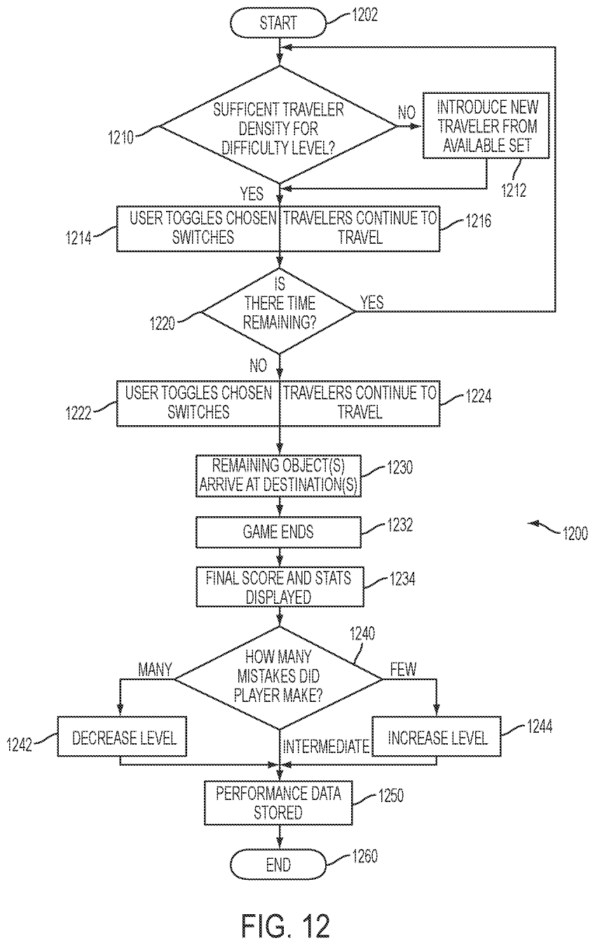

Task difficulty can be moderated by a number of factors including speed, frequency, and distribution of the moving objects, i.e., travelers, such as the trains 102. In an embodiment, the main gameplay flow may be is based on varying levels of traveler/train frequency, such as is illustrated by way of example in FIG. 9 and FIG. 10). Each traveler/train can appear at a source indicator 322 of the network of paths and switches, which for illustrative purposes can be represented by the mouth of a tunnel in the side of a mountain. As is known in the art, the appearance of a new moving object, such as a yellow train 102Y (FIG. 9) or a black train 102B (FIG. 10) can be referred to as a spawning. Each traveler/train may or may not spawn from the source indicator 322 with a period regulated in such a way that travelers/trains and/or their intended paths do not overlap. When the spawn period is due, the historical density of the most recently spawned travelers/trains may be calculated. If the historical density is below a density threshold, as explained in more detail below with respect to the flow diagram 1200 of FIG. 12, then a new traveler/train may be spawned. Otherwise, a new traveler may not be spawned.

According to aspects of the disclosed subject matter, at the beginning of each spawn period, this decision may be updated, e.g., in order to dynamically adjust the difficulty of the training to the recent performance of the user/player. According to another example of the disclosed subject matter, each traveler/train can be caused by the user computing device to move at a constant speed, though this could be varied in other implementations. At each switch the traveler/train passes over, the correctness of the traveler's path may be reassessed, as is explained in more detail with regard to the flow diagram 1200 of FIG. 12). If the remaining network of paths and switches that the traveler/train will pass through in the future contains only the corresponding destination of the traveler/train, then the traveler can be evaluated by the user computing device as being on a the correct path the allowed density threshold can be increased by the user computing device, thereby increasing traveler/train frequency and increasing the game play difficulty.

On the other hand, if the remaining network of paths and switches that the traveler/train will pass through from its current position does not contain the corresponding destination, then the traveler/train may be evaluated by the user computing device to be on an incorrect path and the density threshold can be decreased by the user computing device, thereby decreasing traveler frequency, and decreasing the difficulty of the game play. Thereby the frequency component of the difficulty level can be reassessed in real time, i.e., after each traveler/train passes over any particular switch. In one embodiment, a variable representing frequency can be stored internally, e.g., on a memory within or accessible to the computing device, and could also be displayed to the user. A calculation of the optimal frequency of travelers/trains can be calculated from a range of accuracies, e.g., taken from a large number of users. A curve of the optimal frequency can be made to increase rapidly at first and thereafter diminish the rate of increase, e.g., in order to exercise the proximal zone of development for users of a wide range of cognitive abilities and experience with related exercises. Alternative implementations may use other methods to determine spawn rate, such as probability functions, e.g., Bayesian adaptation.

According to aspects of embodiments of the disclosed subject matter, e.g., to ensure a smooth distribution of travelers/trains, each traveler/train that is spawned can be determined by shuffling the order of one of each traveler/train corresponding to each destination and selecting a next available traveler. As an example, during a beginning of the session, at a trial having relatively lower difficulty, e.g., only the first half of the travelers/trains may be eligible to be spawned, and, accordingly only destination indicators for such travelers/trains would appear on the network of paths and switches, and, also accordingly, fewer switches may need to be traversed. That is, for a relatively easy network of paths and switches, e.g., as illustrated in the tutorial screen displays of FIGS. 6 and 8, only two trains are spawned, a black train 102B and a red train 102R, and destination indicators, e.g., farms for a black destination 122B, a red destination indicator 122R and a green destination indicator 122G are displayed. In the case of the green destination indicator 122G, only one switch setting between the source indicator 322 and the green destination indicator 122G, i.e., switch 116a, needs to be selected to arrive there, while for the black destination 122B and red destination indicator 122R, two switch position settings need be selected, i.e., switch 116a and switch 116b. In the example of FIG. 8 only switch 116a need be set to reach the black destination indicator 122B, but two switches 116a and 116b need to be set to distinguish between the black destination indicator 122B and the green destination indicator 122G.

After the user/player has been assessed to have correctly directed a few travelers/trains, then the variety of the travelers can, e.g., relatively rapidly increase, e.g., to include one traveler/train for each destination in the network, which may then also be followed by randomly selected travelers/trains from the available group for the particular network being displayed. If a player directs travelers/trains incorrectly, then the frequency may be decreased by the user computing device until, after the user directs many trains incorrectly, up to, e.g., some selected threshold, then the frequency can drop down to a minimum, and the variety of eligible travelers/trains to spawn also can be reduced by the user computing device until the player again directs a minimum number of sequential travelers/trains correctly.

In one embodiment, the period of the spawn, especially in earlier less difficult trials can be selected to be slightly greater than the period of traversing one tile, i.e., a section of a grid defining the area of the transportation network, e.g., containing a switch, a destination indicator, a given length of track, etc. In such a manner the player/user may prioritize directing an earlier traveler/train only a moment before having to direct a later traveler, i.e., select the switch positions, such as for switches 116a and 116b in FIGS. 6 and 8 for each new traveler/train. A longer spawn period can also have the benefit that the user/player can distinguish the arrival of each of multiple travelers/trains having traversed the same number of tiles, ile, passed through the same tiles while going to different destinations, e.g., by visual and/or auditory cues that, according to aspects of the disclosed subject matter may happen slightly one after another.

By way of example, as can be seen in the screen display 600 of FIG. 6, a red train 102R is traversing a switch 116b which is set to send the red train 102R straight across switch 116b. This will take the red train 102R to the black destination indicator 122B, i.e., be an incorrect result of the trial comprising getting the red train 102R to the red destination indicator 122R, i.e., by having the switch 116b in the position to direct the red train to the red destination indicator 122R, i.e., downward as illustrated in FIG. 6. Also as shown in FIG. 6 the user computing device is displaying the message, “That train went to the wrong destination indicator. Click both switches to direct each train to the your matching destination marker.” According to aspects of embodiments of the disclosed subject matter, the user/player may then be given the opportunity to repeat this trial until the correct path is created through the transportation network from the source indicator 322 to the correct destination indicator.

The board configuration of the respective transportation routing network can determine the difficulty of the overall session as is illustrated by way of example in FIG. 9 and FIG. 10, which may illustrate essentially a highest level of complexity and variation of travelers/trains and destination indicators (FIG. 9) and an intermediate level of complexity and variation of travelers/trains and destination indicators (FIG. 10). The process of generating a dynamic board configuration, according to aspects of the disclosed subject matter can involve the selection of a number of distinct destinations. Each destination color and shape, e.g., a black farm such as destination indicator 122B or a black train station 122B2 as illustrated in FIG. 9, which combination can be ranked and sorted by a session difficulty level. The difficulty level and number of destinations may be utilized by the user computing device to determine the size of the playing area, with more destinations correlating to a larger area or at least a more densely packed area. It will be understood that this density may also be determined by the display resolution, the desired sizes for the illustrated destination indicators and switches, etc. The use of multiple destination indicators can be utilized, e.g., to increase game complexity. As an example, the extra colored destination indicators may be deemed incorrect and be placed in the network as a visual distraction. They may be deemed incorrect at some times and correct at others, such that, e.g., after one traveler/train of each color has been spawned, or after sole selected time period or the like, the correct destination indicator for the associated color may switch from a farm destination indicator to a train station destination indicator and later shift back.

According to aspects of the disclosed subject matter, a player can skip the interactive tutorial or complete the interactive tutorial with few errors, and thus the user computing device can initially starts the game play at some determined level of difficulty, such as may be determined by a minimum number of destinations. This could be, e.g., three as illustrated in FIG. 8, and could extend to fourteen, as illustrated by way of example in FIG. 9, although other numbers of destinations could be configured at intermediate levels of difficulty, such as six destination indicators as illustrated in FIG. 10. If a user/player makes relatively many mistakes during the interactive tutorial, or even game play, the user computing device can select a smaller grid with which to start the actual trials of a session, such as is shown in FIG. 6 at this stage of the development of the user/player.

Turning now to FIG. 9, there is shown a screen display 900. Screen display 900 can include, a game play information tab 902, which may contain a time block 910 and a score block 912. The Screen display 900 may also include, in addition to the travelers/trains and destination indicators discussed above, a yellow train 102Y, a yellow destination indicator 122Y, a yellow station destination indicator 122Y2, a blue train 102BL, a blue destination indicator 122BL, a blue station destination indicator 122BL2,

a purple train 102P, a purple destination indicator 122P, a purple station destination indicator 122P2, a green train 102G, a green destination indicator 122G, a green station destination indicator 122G2, a red destination indicator 122R, a black destination indicator 122B, and a white destination indicator 122W.

It can be seen that setting the path from the source indicator 322 to a given destination indicator can involve setting the positions for two or more switches. For example, for the yellow destination indicator 122Y and the black destination indicator 122B two switches 116 are engaged and up to five switches are engaged for the purple train 112P2 to arrive at the purple destination indicator 122P. the black train station destination indicator 112B2, which may be another way to increase difficulty, i.e., making all or most of the locations of one type of destination very difficult to reach, especially with multiple trains on the tracks and multiple switch positions to consider to get them all to a respective destination.

Turning now to FIG. 10, there is illustrated a screen display 1000. The screen display 1000, in addition to the farm destination indicators illustrated in FIG. 9, less the white farm destination indicator 122W, illustrates switches including switch 116v, switch 116w, switch 116x, switch 116y and switch 116z. It can be seen that the positions of switches 116x, 116y and 116z are necessary to distinguish the paths to the red destination indicator 122R and the purple destination indicator 122P, and the positions of switches 116x, 116y and 116v are needed to distinguish the yellow destination indicator 122Y and the green destination indicator 122G while only the switches 116x and 116w need be set to distinguish the black destination indicator 122B from the blue destination indicator 122B1. Also, the user has maintained or toggled positions for switches 116x that will take the black train 102B away from the path to the black destination indicator 122B and the yellow train 112Y is well off course, heading for the purple destination indicator 122P, with only the red train 102R and the trailing black train 102B still having a chance to be properly directed to the respective red destination indicator 122R and black destination indicator 122B which would require in the interim resetting the position of the switch 116x and the switch 116z.

In some configurations, the playing area/transportation network can be restrictable to a grid, though other implementations are not excluded from the layout designs. As noted above, such a grid can be comprised of tiles (not shown), e.g., square tiles marking the grid. On any given grid, the source indicator 322 can be randomly placed, e.g., at a generally exterior tile within the grid of tiles, e.g., to increase the novelty of the exercise of performing trials on a given unique transportation network of destinations, paths and switches, when repeated over a number of sessions for a user(s). For tiles connected to the source indicator, a tile may either be a path comprising, e.g., a directed arc of track, a switch, e.g., a branching switch, or a destination indicator, connected to the end of a track on a track tile, with the remaining tiles left blank or filled with visual scenery not relevant to the task(s) of a trial within a session, during which according to an embodiment the grid would remain static. An arc or switch may be generated by the user computing device with a random facing that can, e.g., continue the current path straight, turn left by 90 degrees, or turn right by 90 degrees, so as to interlock with a track section or switch on its adjacent tiles. Likewise, from a switch the next arc or switch can be generated to continue until each of the predetermined number of destinations has exactly one path leading to it from the source indicator, i.e., according to aspects of at least one embodiment of the disclosed subject matter, there may be no cycles in the paths, and no paths that merge together. In this manner a criteria for utilizing a binary tree can be maintained. Other path designs, however, can be employed without departing from the scope of the disclosure and thus, the disclosure is not limited to a binary tree structure.

A traveler/train can pass over some number of switches to reach a destination. It has been determined that configurations with low statistical population variance of the number of switches to traverse correlate to higher accuracy of trains correctly directed. To exercise each user/player at their proximal zone of development, a session difficulty level can determine the configuration of the transportation network comprising the playing board and influence the population variance of the number of switches. According to aspects of embodiments of the disclosed subject matter, a player at a low difficulty is usually presented with configurations that have less variance in the number of switches to traverse than a player at a higher level difficulty. At a lower variance, the network of paths and switches on the board displayed on the screen display by the user computing device, can appear more organized, e.g., more evenly divided. In terms of a binary tree, a low variance in the height of each destination can indicate the network is more balanced, but other network structures could yield different difficulty relationships.

The current number of correctly directed travelers/trains, total number of travelers/trains presented in a session, and time remaining can be displayed, e.g., in the game play tab 902, e.g., for the user/player to be able to measure progress. After a fixed time interval, e.g., 120 seconds, which could be dynamically adjusted, e.g., based on the performance of the user/player, traveler/train spawning can be caused to cease, and, subsequently, when the last remaining traveler/train traverses the applicable part of the network and arrives at some destination, the session/game of the user/player can be terminated by the user computing device. The user/player can then be shown a results screen display 1100, e.g., as illustrated by way of example in FIG. 11, on which the score 1102 can be displayed alongside the number of travelers/trains successfully directed, the overall number of travelers/trains directed 1102, and the number of destinations 1106 that the player will be presented with in any next session, can be seen in the illustration of screen display 1100 seen in FIG. 11. FIG. 11 also illustrates a “Continue” button and game information 1104, such as “If you had +1 more correct you would get another destination marker.”

Before the main gameplay, the player can be presented with the number of destinations, a representation of the total possible number of destinations achievable, and the goal to achieve the next level of difficulty, which is, e.g., by making few mistakes. After the session is complete, the number of mistakes can be evaluated, e.g., by the user computing device, e.g., to determine the number of destinations that would optimally exercise the skill of the user/player at the current performance level of the user/player. Making few mistakes increases the number of destinations. Making many mistakes decreases the number of destinations in the next session. To further optimize the exercise of a player who has not quite achieved the next destination during this session, there may be further subdivided levels of difficulty, in which, e.g., the minimum frequency, maximum frequency, and the variance of the switch counts may be increased if the player made only slightly more mistakes than would dictate an increase in the number of destinations. Such factors can be quantified and utilized by the user computing device in determining the level achieved by the player. In an embodiment, a level of the user/player on the last trial can be recorded by the user computing device and the user computing device can control the level that is selected for the player in subsequent play of the game. In other implementations, other factors could be incorporated to determine the subsequent starting level.

Turning now to FIG. 12 there is shown an example of a game play flow diagram 1200, according to aspects of embodiments of the disclosed subject matter. The game play flow diagram 1200 can include a start block 1202. After the start block 1202 a decision block 1210 can make the decision of whether there is a sufficient traveler/train density for difficulty level? If not then in block 1212 the user computing device can introduce a new traveler from an available set. That is, if there are not enough travelers, e.g., trains in the existing transportation routing network another train can be introduced at the source indicator. In block 1214 the user toggles chosen switches and in block 1216 the travelers/trains continue to travel on the respective tracks within the network. The user computing device in decision block 1220 can then make the determination of whether there is time remaining, assuming a given training session is determined by the passage of s a selected time period. If there is the user computing device can loop to the decision block 1210 again. If there is no time remaining for introducing more travelers/trains, then in block 1222 the user toggles chosen switches and in block 1224 travelers continue to travel. In block 1230 a remaining object(s) arrives at a destination(s) and in block 1232 the game ends.

In block 1234 the user computer can display a final score and scoring statistics on the user interface display. The user computing device can then go to another decision block 1240 where the user computing device can determine how many mistakes did the player make, i.e., not directing a respective traveler/train to the unique destination by positioning the switch(es) in a path from the source indicator to the particular unique destination in the proper position(s). If the number of mistakes is determined to be “many,” e.g., more than some selected threshold, then in block 1242 the user computing device can decrease the game difficulty. If considered to be “Few,” e.g., less than some selected threshold, then in block 1244 the user computing device can increase the game difficulty, and if “intermediate,” e.g., between the two selected thresholds then the game difficulty can be unchanged. In block 1250 the user computing device can store user performance data stored and in block 1260 end the process flow.

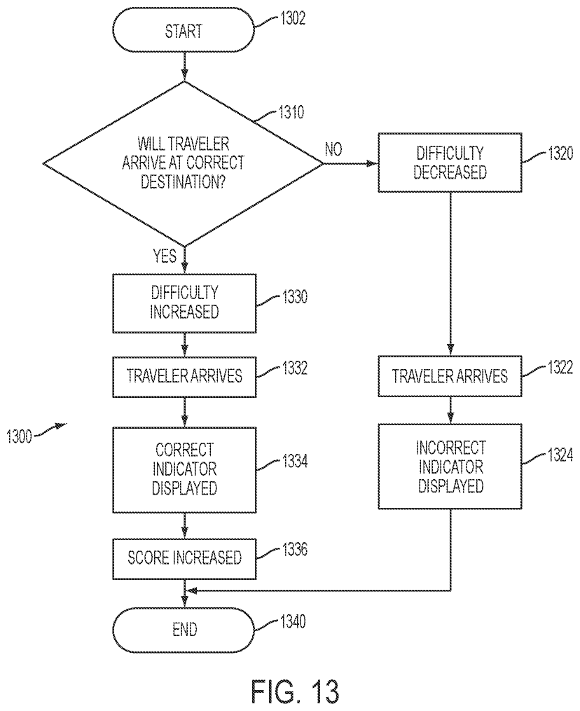

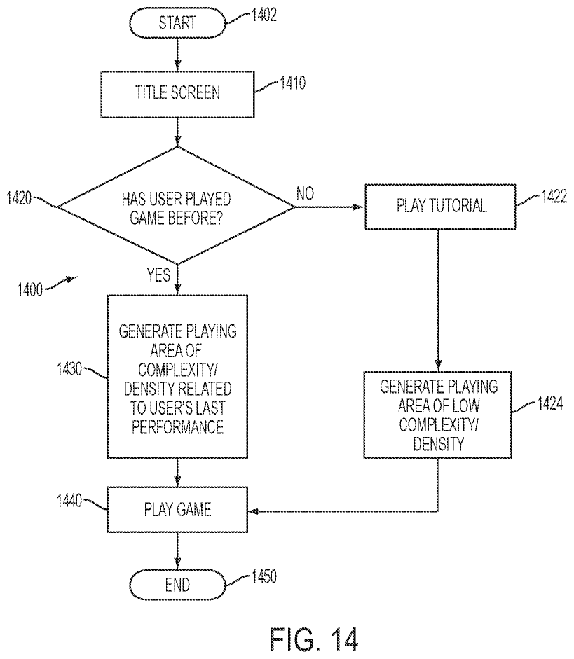

Turning now to FIG. 13 there is shown an example of a flow diagram 1300 for changing the game difficulty during game play, according to aspects of embodiments of the disclosed subject matter. The flow diagram 1300 has a start block 1302 followed by a decision block 1310 in which the user computing device can make a determination of whether a given traveler/train will arrive at the respective unique destination, i.e., whether the intervening switches are in the right positions. If no, then in block 1320 the user computing device can decrease the game difficulty. It will be understood that game difficulty can be modified, e.g., by modifying the size of the transportation routing network, i.e., number of unique destinations and number of switches intermediate the source indicator and each unique destination or by changing the density of travelers appearing in the network at any given time, i.e., the rapidity of production of the trains at the source indicator, and to some degree the repetition of the same color train so that the same route applies for each without the need to change any switch positions. Ordinarily, however, during a given session made up of a plurality of trials, i.e., appearances of a traveler/train for proper routing, will not have the network modified, and therefore other means of changing difficulty, such as traveler/train density can be used.

Other effects on difficulty could be, e.g., the order of some or all of the appearances of respective travelers/trains being selected to maximize the number of switches that need to be changed in position from one unique route to the next and/or shorten the timing available to make the changes. It will be understood that these may be selected by the user computing device as part of game difficulty variation or simply randomized, e.g., in an effort to normalize these effect from user session to user session. If the determination in decision block 1310 is “Yes,” then the user computing device in block 1330 can increase the game difficulty, again, typically without changing the network during any given session.

After blocks 1320 and 1330, respectively in block 1322 and block 1332 the user computing device can determine that the traveler has arrive at the destination for which it was headed and, according, in block 1324 the user computing device can generate an incorrect indicator, e.g., an “X,” which can, e.g., be displayed on the destination indicator, and in block 1334 can generate a correct indicator, e.g., a check mark, which can similarly be displayed on the displayed. In block 1336 the user computing device can increase the score for the user and then in block 1340 this portion of the process flow can end, which may also entail a feedback loop to block 1302.

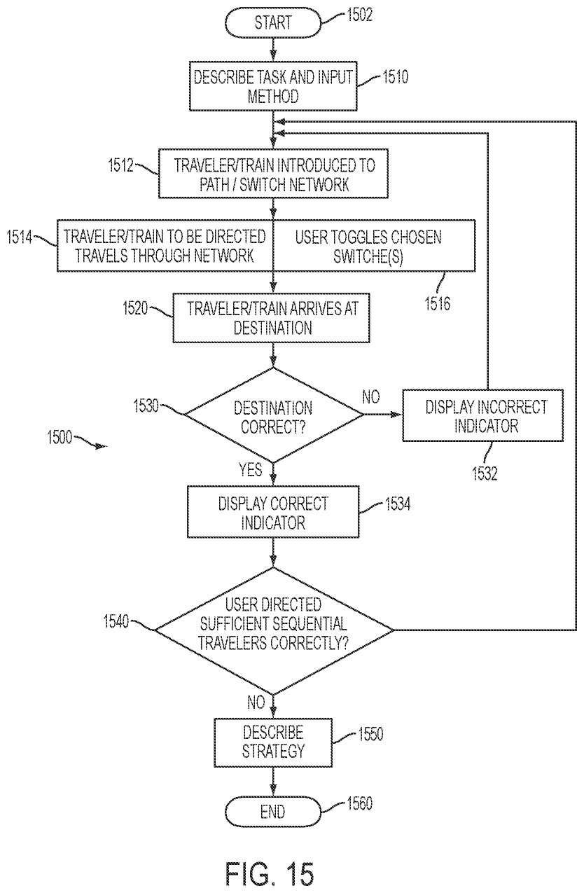

Turning now to FIG. 15 there is shown a game start process block diagram 1400, according to aspect of embodiments of the disclosed subject matter. Flow diagram 1400 has a start block 1402 followed by a block 1410 in which the user computing device can display the game title, e.g., “Train of Thought.” In a decision block 1420 the user computing device can make a determination of whether the user has played the cognitive training game before. If not, then in block 1422, the user computing device can begin the user off with a tutorial, by, e.g., in block 1422 starting the tutorial, during which, in block 1424 the user computing device can generate a playing area, e.g., a transportation routing network, of low complexity/density, such as with two unique destinations, e.g., black destination indicator 122B and red destination indicator 122R and one switch 116 (such as illustrated in FIGS. 3-5), or three destinations, e.g., black destination indicator 122B, red destination indicator 122R and green destination indicator 122G, with two switches 116a and 116b (such as illustrated in FIGS. 6 and 8). If the user has played the game before, then in block 1430 the user computing device can generate a playing area of complexity related to last performance of the user, e.g., a slightly more complex network such as illustrated in FIG. 8. Then in block 1440 the user computing device can go to a play the game mode, and in block 1450 this part of the process flow can come to an end.

Turning now to FIG. 15 there is shown a flow diagram 1500, which can have a start block 1502. After the start block 1502, in block 1510 the user computing device can display on the user computing device user interface display information to describe the task and the input method(s) the user can use during the game play. In block 1512 the user computing device can introduce into the displayed transportation routing network (spawn) a traveler/train onto a path/track in the network, e.g., leading from the source indicator. Therefore in block 1514 the user computing device can begin to track the traveler/train to be directed by the user as it travels through the network according to the position of any switch(es) in its path.

In block 1516 the user computing device can determine when and if the user toggles any chosen switch(es) and in block 1520 the user computing device can determine that a traveler/train arrives at a destination. Then in decision block 1530 the user computing device can determine if the destination reached was correct, e.g., the destination matched the color of the traveler/train. If no then in block 1532 the user computing device can cause to be displayed, e.g., on the destination indicator, an incorrect indicator, and if correct then in block 1534 the user computing device can cause to be displayed a correct indicator.

In decision block 1540 the user computing device can determine whether the user directed a sufficient selected number of travelers/trains, e.g., in a sequential order of the travelers/trains correctly. If so, then the process flow can loop back to the introduction of a new traveler/train in block 1512. If not, then the process flow can move to block 1550 and a tutorial statement can be displayed to the user, e.g., explaining a successful strategy. This portion of the process flow can then end in block 1560.

It will be understood by those in the art that a method and apparatus for conducting cognitive training exercises are described. In the exemplary exercises, the exercises can be adaptable to train divided and distributed attentional abilities in an intuitive, engaging and adaptively challenging way to enhance cognition. The exercises may engage a user in a task where the user directs a continuous stream of items, e.g., transportation vehicles, such as trains, to a destination by, for example, toggling switches on tracks, e.g., to create a path in real time from a source indicator of the transportation vehicles to a unique destination. Through attentional and executive control mechanisms, the user continuously track the trains, plan their routes, and toggle the switches when necessary in order to complete the physically realistic task, and, e.g., can adjust the paths in real time to allow for a first vehicle passing over a switch to go in the necessary desired direction through the switch and a subsequent transportation vehicle to go in another selected necessary desired direction through the switch.

Thus, a method and apparatus for enhancing a cognitive ability of a user, are disclosed which may comprise: conducting, via a user interface display of a user computing device, a training session which may comprise: presenting, via the user interface display of the user computing device, a transportation routing network, e.g., a network of track having a source of travelers, e.g., trains engines and a respective unique destination for each traveler and a path from the source to the respective unique destination, each path may comprise at least one direction modification element, such as a switch, operable by the user, via the user interface display of the user computing device, to correctly direct the traveler from the source to the respective unique destination; displaying to the user, via the user interface display of the user computing device, such a traveler moving along such a path from the source to the at least one direction modification element; and allowing the user, via the user interface display of the user computing device, to control the position of the at least one direction modification element so as to direct the traveler from the source to the respective unique destination.

The method and apparatus may further comprise wherein the transportation routing network comprises a multipath transportation routing network comprising a plurality of unique destinations each connectable to the source through a unique path in a network of paths. The traveler/train may comprise a plurality of travelers/trains sequentially delivered from the source and uniquely identified with one of the plurality of unique destinations. The method and apparatus may further comprise recording, via the user computing device, whether the user successfully directs a respective traveler/train from the source to the respective unique destination through the control by the user, via the user interface display of the user computing device, of the at least one direction modification element. The method and apparatus may further comprise the multipath transportation routing network comprising tracks for the train engine to follow and each direction modification element may comprise a switch for the train engine to pass over. The method and apparatus may further comprise wherein the respective traveler and the respective unique destination for the traveler are identified by a same color.

The method and apparatus may further comprise wherein the complexity of the training session being determined by the user computing device from at least one of: the number of unique destinations, the number of direction modification elements between the source and the respective unique destination and the speed of delivery of travelers from the source. The method and apparatus may further comprise enhancing the complexity of the training session by requiring the user, via the user interface display of the user computing device, to sequentially control the position of at least one direction modification element at least twice to direct a first traveler to a first unique destination and a second traveler to a second unique destination after the first traveler passes through the direction modification element and before the second traveler reaches the direction modification element, wherein the second traveler is displayed to be moving toward the respective at least one direction modification element before the first traveler has passed through the respective at least one direction modification element. The method and apparatus may further comprise increasing or decreasing, via the user computing device, the complexity of the training session according to user performance during the training session. It will be understood that controlling the position of a respective switch can include leaving the switch alone, i.e., not changing the position in which the switch currently is, in order for the first and second engines to travel through the switch to the same output track from the switch where that output track is a part of the path from the source to the respective first destination and second destination for the first train and the second train.

Also disclosed is a machine readable medium storing instructions that, when executed by a computing device cause the computing device to perform a method which may comprise conducting a training session comprising: presenting a transportation routing network having a source of travelers and a respective unique destination for each traveler and a path from the source to the respective unique destination, each path comprising at least one direction modification element operable by the user, via the user computing device user interface display, to correctly direct the traveler from the source to the respective unique destination; displaying to the user a traveler moving along a path from the source to the at least one direction modification element; and allowing the user to control the position of the at least one direction modification element so as to direct the traveler from the source to the respective unique destination. The machine readable medium may comprise, wherein the transportation routing network comprises a multipath transportation routing network comprising a plurality of unique destinations each connectable to the source through a unique path in a network of paths.

The systems and methods according to aspects of the disclosed subject matter may utilize a variety of computer systems, communications devices, networks and/or digital/logic devices for operation. Each may in turn utilize a suitable computing device which can be manufactured with, loaded with and/or fetch from some storage device, and then execute, instructions that cause the computing device to perform a method according to aspects of the disclosed subject matter. A computing device can include without limitation a mobile user device such as a mobile phone, a smart phone and a cellular phone, a personal digital assistant (“PDA”), such as a BlackBerry, a tablet, a laptop and the like. In at least some configurations, a user can execute a browser application over a network, such as the Internet, to view and interact with digital content, such as screen displays. Access could be over or partially over other forms of computing and/or communications networks. A user may access a web-browser, e.g., to provide access to applications and data and other content located on a web-site or a web-page of a web-site.

A suitable computing device may include a processor to perform logic and other computing operations, e.g., a stand-alone computer processing unit (“CPU”), or hard wired logic as in a microcontroller, or a combination of both, and may execute instructions according to its operating system and the instructions to perform the steps of the method. The user's computing device may be part of a network of computing devices and the methods of the disclosed subject matter may be performed by different computing devices, perhaps in different physical locations, cooperating or otherwise interacting to perform a disclosed method. For example, a user's portable computing device may run an app alone or in conjunction with a remote computing device, such as a server on the Internet. For purposes of the present application, the term “computing device” shall include any and all of the above discussed logic circuitry, communications devices and digital processing capabilities or combinations of these. A computing device can include without limitation a mobile user device such as a mobile phone, a smart phone and a cellular phone, a personal digital assistant (“PDA”), such as a BlackBerry, a tablet, a laptop and the like. In at least some configurations, a user can execute a browser application over a network, such as the Internet, to view and interact with digital content, such as screen displays. Access could be over or partially over other forms of computing and/or communications networks.

Certain embodiments of the disclosed subject matter may be described for illustrative purposes as steps of a method which may be executed on a computing device executing software, and illustrated, by way of example only, as a block diagram of a process flow. Such may also be considered as a software flow chart. Such block diagrams and like operational illustrations of a method performed or the operation of a computing device and any combination of blocks in a block diagram, can illustrate, as examples, software program code/instructions that can be provided to the computing device or at least abbreviated statements of the functionalities and operations performed by the computing device in executing the instructions. Some possible alternate implementation may involve the function, functionalities and operations noted in the blocks of a block diagram occurring out of the order noted in the block diagram, including occurring simultaneously or nearly so, or in another order or not occurring at all. Aspects of the disclosed subject matter may be implemented in parallel or seriatim in hardware, firmware, software or any combination(s) of these, co-located or remotely located, at least in part, from each other, e.g., in arrays or networks of computing devices, over interconnected networks, including the Internet, and the like.

The instructions may be stored on a suitable “machine readable medium” within a computing device or in communication with or otherwise accessible to the computing device. As used in the present application a machine readable medium is a tangible storage device and the instructions are stored in a non-transitory way. At the same time, during operation, the instructions may at sometimes be transitory, e.g., in transit from a remote storage device to a computing device over a communication link. However, when the machine readable medium is tangible and non-transitory, the instructions will be stored, for at least some period of time, in a memory storage device, such as a RAM, a ROM, a magnetic or optical disc storage device, or the like, arrays and/or combinations of which may form a local cache memory, e.g., residing on a processor integrated circuit, a local main memory, e.g., housed within an enclosure for a processor of a computing device, a local electronic or disc hard drive, a remote storage location connected to a local server or a remote server access over a network, or the like. When so stored, the software will constitute a “machine readable medium,” that is both tangible and stores the instructions in a non-transitory form. At a minimum, therefore, the machine readable medium storing instructions for execution on an associated computing device will be “tangible” and “non-transitory” at the time of execution of instructions by a processor of a computing device and when the instructions are being stored for subsequent access by a computing device.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of enhancing a cognitive ability of a user by promoting divided attentional abilities, comprising:
conducting, via a user interface display of a user computing device, a training session comprising:
compiling, via the user interface display of the user computing device, a routing network having one or more travelers having an assigned traveler identifier, a source for each of the one or more travelers, one or more destination indicators having an assigned destination indicator identifier, at least one respective destination having the same assigned identifier for each of the one or more travelers having an assigned destination identifier, a path from the source for the one or more travelers to the respective destination for the one or more travelers, each network comprising at least one direction modification element to direct a traveler of the one or more travelers from the source to the respective destination;
controlling, via the computing device, without user input the traveler indicator for the one or more travelers, the source for the one or more travelers, a speed of motion for the one or more travelers, a frequency of departure from the source for the one or more travelers, and a distribution of departure times from the source for one or more travelers;
presenting, via the user interface display of the user computing device, one or more traveler moving along the path from the source to the at least one direction modification element;
receiving a toggle input or no toggle input selection via the user interface display of the user computing device, to control a position of the at least one direction modification element so as to direct the traveler to the respective destination for the traveler;
calculating a user response score from the number of one or more travelers that were correctly directed by the user to the respective destination of the one or more travelers; and
increasing or decreasing via the user computing device a complexity of a subsequent gameplay session according to the user response score.

2. The method of claim 1 wherein the routing network comprises a multipath routing network comprising a plurality of unique destinations each connectable to the source through a unique path in a network of paths.

3. The method of claim 2 wherein the traveler comprises a plurality of travelers sequentially delivered from the source and uniquely identified with one of the plurality of unique destinations.

4. The method of claim 3 wherein each of the plurality of travelers comprises a representation of a train and the multipath routing network comprises tracks for the train to follow and each direction modification element comprises a switch for the train to traverse.

5. The method of claim 3 wherein the identifier is one or more of shape, color, and size.

6. The method of claim 3 wherein each of the plurality of travelers comprises a representation of a vehicle and the routing network comprises paths for the vehicle to follow.

7. The method of claim 1 further comprising adjusting, by the user computing device, a complexity of the training session by adjusting at least one of: a number of unique destinations, a number of direction modification elements between the source and a number of respective unique destination and a speed of delivery of travelers from the source.

8. The method of claim 7 further comprising:
enhancing the complexity of the training session by requiring the user, via the user interface display of the user computing device, to sequentially control the position of at least one direction modification element at least twice to direct a first traveler to a first unique destination and a second traveler to a second unique destination after the first traveler passes through the direction modification element and before the second traveler reaches the direction modification element, wherein the second traveler is displayed to be moving toward the respective at least one direction modification element before the first traveler has passed through the respective at least one direction modification element.

9. The method of claim 8 further comprising:
increasing or decreasing, via the user computing device, the complexity of the training session according to user performance during the training session.

10. An apparatus for enhancing a cognitive ability of a user, comprising:
a user computing device configured to:
conduct a training session, utilizing a user interface display of the user computing device, comprising:
compiling, via the user interface display of the user computing device, a routing network having one or more travelers having an assigned traveler identifier, a source for each of the one or more travelers, one or more destination indicators having an assigned destination indicator identifier, at least one respective destination having the same assigned identifier for each of the one or more travelers having an assigned destination identifier, a path from the source for the one or more travelers to the respective destination for the one or more travelers, each network comprising at least one direction modification element to direct a traveler of the one or more travelers from the source to the respective destination;
controlling, via the computing device, without user input the traveler identifier for the one or more travelers, the source for the one or more travelers, a speed of motion for the one or more travelers, a frequency of departure from the source for the one or more travelers, and a distribution of departure times from the source for one or more travelers;
presenting, via the user interface display of the user computing device, one or more traveler moving along the path from the source to the at least one direction modification element;
receiving a toggle input or no toggle input selection via the user interface display of the user computing device, to control a position of the at least one direction modification element so as to direct the traveler to the respective destination for the traveler;
calculating a user response score from the number of one or more travelers that were correctly directed by the user to the respective destination of the one or more travelers; and
increasing or decreasing via the user computing device a complexity of a subsequent gameplay session according to the user response score.

11. The apparatus of claim 10 wherein the routing system comprises a multipath routing network comprising a plurality of unique destinations each connectable to the source through a unique path in a network of paths.

12. The apparatus of claim 10 wherein the traveler comprises a plurality of travelers sequentially delivered from the source and uniquely identified with one of the plurality of unique destinations.

13. The apparatus of claim 11 further comprising:
the training session further comprising, recording, via the user computing device, whether the user successfully directs a respective traveler from the source to a respective unique destination through the control by the user, via the user computing device user interface display, of the at least one direction modification element.

14. The apparatus of claim 11 wherein each of the plurality of travelers comprises a representation of a train and the multipath routing network comprises tracks for the train to follow and each direction modification element comprises a switch for the train to traverse.

15. The apparatus of claim 12 wherein a respective unique destination for the traveler are identified by one or more of shape, color and size.

16. The apparatus of claim 12 wherein each of the plurality of travelers comprises a representation of a vehicle and the routing network comprises paths for the vehicle to follow.

17. The apparatus of claim 10 further comprising determining a complexity of the training session, the user computing device, from least one of: a number of unique destinations, a number of direction modification elements between the source and a respective unique destination and a speed of delivery of travelers from the source.

18. The apparatus of claim 17 further comprising:
the user computing device further configured to enhance the complexity of the training session by requiring the user, via the user computing device user interface display, to sequentially control the position of at least one direction modification element at least twice to direct a first traveler to a first unique destination and a second traveler to a second unique destination after the first traveler passes through the at least one direction modification element and before the second traveler reaches the at least one direction modification element, wherein the second traveler is displayed to be moving toward the respective at least one direction modification element before the first traveler has passed through the respective at least one direction modification element.

19. The apparatus of claim 18 further comprising:
the user computing device configured to increase or decrease the complexity of the training session according to user performance during the training session.

20. A machine readable medium storing instructions that, when executed by a computing device cause the computing device to perform a method comprising:
conducting a training session comprising:
conducting, via a user interface display of a user computing device, a training session comprising:
compiling, via the user interface display of the user computing device, a routing network having one or more travelers having an assigned traveler identifier, a source for each of the one or more travelers, one or more destination indicators having an assigned destination indicator identifier, at least one respective destination having the same assigned identifier for each of the one or more travelers having an assigned destination identifier, a path from the source for the one or more travelers to the respective destination for the one or more travelers, each network comprising at least one direction modification element to direct a traveler of the one or more travelers from the source to the respective destination;
controlling, via the computing device, without user input the traveler identifier for the one or more travelers, the source for the one or more travelers, a speed of motion for the one or more travelers, a frequency of departure from the source for the one or more travelers, and a distribution of departure times from the source for one or more travelers;
presenting, via the user interface display of the user computing device, one or more traveler moving along the path from the source to the at least one direction modification element;
receiving a toggle input or no toggle input selection via the user interface display of the user computing device, to control a position of the at least one direction modification element so as to direct the traveler to the respective destination for the traveler;
calculating a user response score from the number of one or more travelers that were correctly directed by the user to the respective destination of the one or more travelers; and
increasing or decreasing via the user computing device a complexity of a subsequent gameplay session according to the user response score.

21. The machine readable medium of claim 20 wherein the routing network comprises a multipath routing network comprising a plurality of unique destinations each connectable to the source through a unique path in a network of paths.
